(19) United States
(12) Patent Application Publication
(10) Pub. No.: US 2010/0283717 A1
(43) Pub. Date: Nov. 11, 2010

(54) ILLUMINATING DEVICE AND DISPLAY DEVICE

(76) Inventors: Hidekazu Oka, Osaka (JP); Takashi Morimoto, Osaka (JP)

Correspondence Address: NIXON & VANDERHYE, PC, 901 NORTH GLEBE ROAD, 11TH FLOOR, ARLINGTON, VA, 22203, US

(21) Appl. No.: 12/679,761

(22) PCT Filed: Jun. 18, 2008
(86) PCT No.: PCT/JP2008/061151

§ 371 Date: May 10, 2010

(30) Foreign Application Priority Data
Sep. 26, 2007 (JP) 2007-249077

(51) Int. Cl. G09G 3/36; G09G 3/34; F21V 7/22; G02F 1/1335

(52) U.S. Cl. 345/102; 345/107; 362/609; 349/67; 362/97.1

(57) ABSTRACT

A display device for performing image display by irradiating light from a light source to a display panel includes a transparent EL sheet which is disposed at aback surface side of the display panel and kept transparent in a non-luminous state, a reflection sheet which reflects the light from the light source to the display panel, a display control unit which controls the image display on the display panel, and a light emission control unit which controls light emission on the transparent EL sheet, wherein when the light emission control unit brings at least a part of a surface of the transparent EL sheet into a luminous state corresponding to the image display on the display panel controlled by the display control unit, an emitted light is irradiated to the display panel together with the light from the light source and the light reflecting from the reflection sheet.

### BACKGROUND OF THE INVENTION

1. Field of the Invention

The present invention relates to a display device provided with an illuminating device for irradiating light to a light transmission type display panel, and more particularly, to a display device for an image display with improved contrast.

2. Description of the Related Art

Generally, a flat type display device, such as a liquid crystal display device provided with a light transmission type liquid crystal display panel for example, has an illuminating device disposed at a back surface side of the liquid crystal display panel. The illuminating device includes a cold cathode fluorescent lamp (hereinafter referred to as CCFL) as a light source for irradiating the light with adjusted property to the back surface side of the liquid crystal display panel. The irradiated light transmits the liquid crystal display panel so as to visualize the image displayed on the front of the liquid crystal display panel.

FIG. 8 schematically illustrates a structure of a conventional liquid crystal display device. A liquid crystal display device 100 illustrated in the drawing includes a liquid crystal display panel 101 for displaying images and an illuminating device 102 disposed at the back surface side.

Light from plural CCFLs 104 arranged in rows inside a low-height box-like chassis 103 transmits an optical sheet 106 and the liquid crystal display panel 101 together with the light reflected at a reflection sheet 105 so as to be viewed by a viewer. The optical sheet 106 at this time adjusts the property of the incident light irradiated from the CCFL 104 into the liquid crystal display panel 101. The structure of the aforementioned type is disclosed in Japanese laid-open Patent Publication No. H11-44863.

Generally the reflection sheet 105 in white has been employed for improving luminance on the screen of the liquid crystal display panel 102 to efficiently reflect the light from the CCFL 104 to the liquid crystal display panel 101. If the peak luminance at the brightest part (white) on the screen of the liquid crystal display panel 101 is intensified, the black portion at the darkest part (black) cannot appear sufficiently darkened, resulting in difficulty in improvement of the contrast ratio. Hence, it is an object of the present invention to provide an illuminating device capable of improving the contrast ratio, and a display device provided with the illuminating device.

### SUMMARY OF THE INVENTION

In order to overcome the problems described above, a preferred embodiment of the present invention provide an illuminating device for irradiating light from a light source to a display panel. The illuminating device includes a transparent EL sheet which is disposed at a back surface side of the display panel and kept transparent in a non-luminous state, and a reflection sheet which reflects the light from the light source to the display panel. When at least a part of a surface of the transparent EL sheet is brought into a luminous state corresponding to image display on the display panel, a light emitted is irradiated to the display panel together with the light from the light source and the light reflecting from the reflection sheet.

It is preferable that the transparent EL sheet is one of a transparent organic EL sheet and a transparent inorganic EL sheet, and that the display panel is a liquid crystal display panel. It is also preferable that a reflectance of at least a part of a surface of the reflection sheet is changed corresponding to the image display on the display panel, and that the reflection sheet is electronic paper. In addition, it is preferable that the light source is arranged on a back surface of the display panel, and that the light source is arranged at a side edge of the display panel.

In another preferred embodiment of the present invention, a display device for performing image display by irradiating light from a light source to a display panel includes a transparent EL sheet which is disposed at a back surface side of the display panel and kept transparent in a non-luminous state, a reflection sheet which reflects the light from the light source to the display panel, a display control unit which controls the image display on the display panel, a light emission control unit which controls light emission on the transparent EL sheet. When the light emission control unit brings at least a part of a surface of the transparent EL sheet into a luminous state corresponding to the image display on the display panel controlled by the display control unit, an emitted light is irradiated to the display panel together with the light from the light source and the light reflecting from the reflection sheet.

It is preferable that the transparent EL sheet is one of a transparent organic EL sheet and a transparent inorganic EL sheet, and that the display panel is a liquid crystal display panel. It is also preferable that the display device further includes a reflectance control unit which controls a reflectance of a surface of the reflection sheet. The reflectance control unit preferably changes the reflectance of at least a part of a surface of the reflection sheet corresponding to the image display on the display panel. In addition, it is preferable that the reflection sheet is electronic paper. It is further preferable that the light source is arranged on a back surface of the display panel, and that the light source is arranged at a side edge of the display panel.

In yet another preferred embodiment of the present invention, a display device for performing image display by reflecting external light such as sunlight to a display panel using a reflection sheet arranged at a back surface side of the display panel includes a transparent EL sheet which is interposed between the display panel and the reflection sheet, and kept transparent in a non-luminous state, a display control unit which controls the image display on the display panel, and a light emission control unit which controls light emission on the transparent EL sheet. When the light emission control unit brings at least a part of a surface of the transparent EL sheet into a luminous state corresponding to the image display on the display panel controlled by the display control unit, an emitted light is irradiated to the display panel together with the light reflecting from the reflection sheet.

It is preferable that the transparent EL sheet is one of a transparent organic EL sheet and a transparent inorganic EL sheet, and that the display panel is a liquid crystal display panel. It is also preferable that the display device further includes a reflectance control unit which controls a reflectance of a surface of the reflection sheet. The reflectance control unit preferably changes the reflectance of at least a part of the surface of the reflection sheet corresponding to the image display on the display panel. In addition, it is preferable that the reflection sheet is an electronic paper.

The aforementioned structure of the present invention is provided with a transparent EL sheet which is disposed at the back surface side of the display panel and kept transparent in a non-luminous state, and a reflection sheet which reflects the light from the light source to the display panel. When at least a part of the surface of the transparent. EL sheet is brought into the luminous state corresponding to the image display on the display panel, the resultant emitted light is irradiated to the display panel together with the light from the light source and the light reflecting from the reflection sheet. If there is a bright display portion for the image display on the display panel, the surface corresponding to the bright display portion on the transparent EL sheet disposed at the back surface side of the display panel is brought into the luminous state, and the rest of the surface is not allowed to be luminous. This makes it possible to emphasize the white portion of the bright display on the display panel. The peak luminance may be intensified at the brightest part (white) while keeping the darkest part (black) of the image displayed on the display panel dark, resulting in an improved contrast ratio.

The reflection sheet which is capable of changing reflectance of at least a part of its surface corresponding to the image displayed on the display panel may be used as the one for reflecting the light from the light source to the display panel. In such a case, if there is a dark display portion for the image display on the display panel, the reflectance of the surface corresponding to the dark display portion on the reflection sheet is changed so as to reduce the light reflecting on such surface. This makes it possible to further darken the black portion of the dark display of the image on the display panel, resulting in a further improved contrast ratio.

The aforementioned transparent EL sheet and the reflection sheet are applicable to the reflection type display device structured to reflect the external light such as sunlight to the display panel using the reflection sheet at the back surface side for the image display without using the light source. In this case, the similar effects as described above may be obtained.

### BRIEF DESCRIPTION OF THE DRAWINGS

FIG. 1 is a schematic view showing a structure of a liquid crystal display device according to a preferred embodiment of the present invention.

FIG. 2 is a schematic view showing a structure of a control circuit that controls a liquid crystal display panel, a transparent organic EL sheet, and a reflection sheet shown in FIG. 1.

FIG. 3 is a schematic view showing a structure of the liquid crystal display panel shown in FIG. 1.

FIG. 4 is a schematic view showing a structure of the transparent organic EL sheet shown in FIG. 1.

FIG. 5 is a schematic view showing a structure of the reflection sheet shown in FIG. 1.

FIG. 6 is a schematic view showing a structure of a liquid crystal display device according to a first modified preferred embodiment of the present invention.

FIG. 7 is a schematic view showing a structure of a liquid crystal display device according to a second modified preferred embodiment of the present invention.

FIG. 8 is a schematic view showing a structure of a conventional liquid crystal display device.

### DETAILED DESCRIPTION OF THE PREFERRED EMBODIMENTS

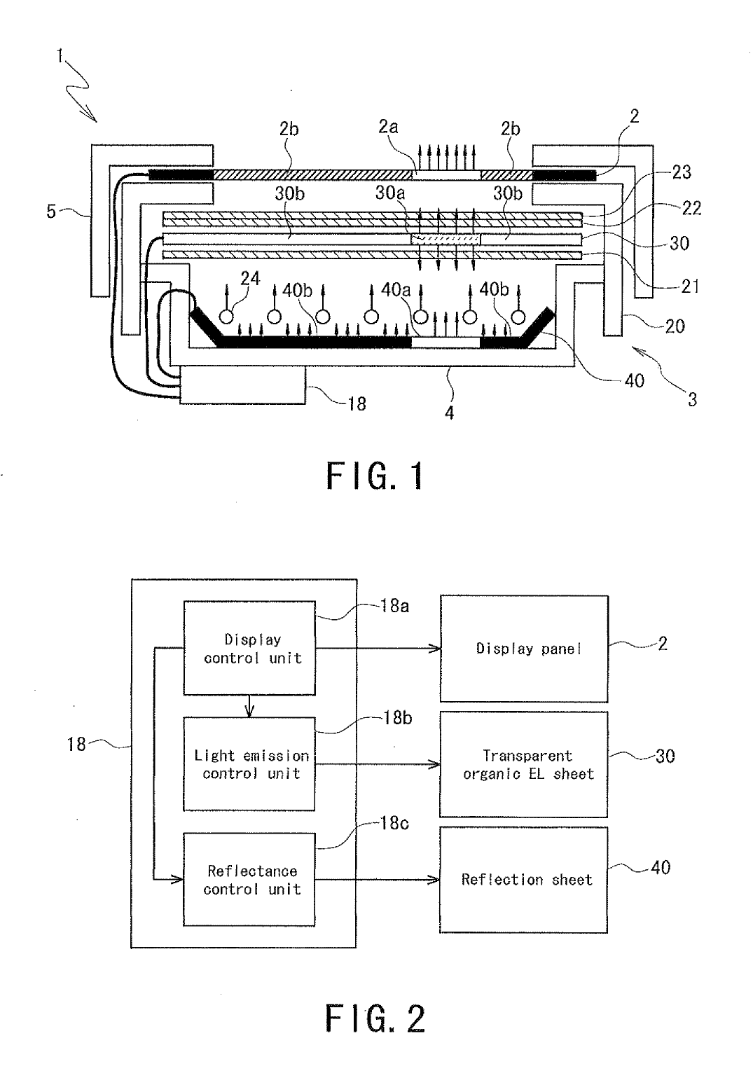

Preferred embodiments according to the present invention will be described in detail referring to the drawings. FIG. 1 schematically illustrates a structure of a liquid crystal display device according to a preferred embodiment of the present invention.

A liquid crystal display device 1 illustrated in the drawing includes a liquid crystal display panel 2 and an illuminating device 3. The liquid crystal display panel 2 is formed by laminating two substrates having liquid crystal sealed therebetween, and fixed to a chassis 4 of the illuminating device 3 with bezels 5.

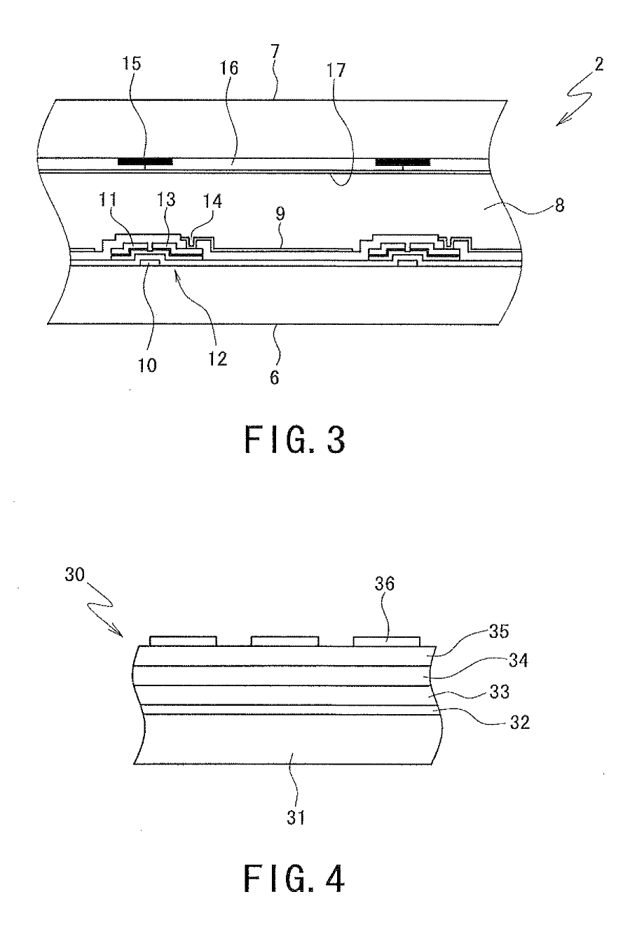

Referring to FIG. 3, a liquid crystal 8 is sealed between a thin film transistor (TFT) substrate 6 and a color filter (CF) substrate 7 which are oppositely arranged to form the liquid crystal display panel 2. The TFT substrate 6 is provided with plural pixel electrodes 9 arranged in matrix. A gate electrode 10 and a source electrode 11 are formed to be orthogonal to each other around the respective pixel electrodes 9. A TFT 12 serving as a switching element is formed beside an intersection between the gate electrode 10 and the source electrode 11.

The TFT 12 is ON/OFF controlled in accordance with a scan signal voltage supplied from the gate electrode 10. An image signal voltage supplied from the source electrode 11 is further supplied to the pixel electrode 9 via a drain electrode 13 and a contact hole 14. An alignment layer (not shown) is formed on the pixel electrode 9 so as to define alignment of the liquid crystal 8 toward a predetermined direction.

A black matrix (BM) 15 is formed on the CF substrate 7 so as to shield the region where the gate electrode 10, the source electrode 11 and the TFT 12 are formed on the TFT substrate 6 from the light. The CF substrate 7 includes a single color layer 16 selected from red, green and blue for each pixel.

A common electrode 17 common to the pixels is formed below the color layer 16. An alignment layer (not shown) is formed below the common electrode 17 so as to define alignment of the liquid crystal 8 toward the predetermined direction.

The thus structured liquid crystal display panel 2 is matrix controlled by a display control unit 18a installed in a control circuit 18 as shown in FIG. 2 for displaying images. The light irradiated from the illuminating device 3 transmits the liquid crystal display panel 2 to visualize the image to be displayed on the front of the liquid crystal display panel 2.

Referring to the drawing, the illuminating device 3 includes a frame 20, optical sheets 21 to 23, a transparent organic EL sheet 30, a CCFL 24, a reflection sheet 40, and a chassis 4. The frame is shaped like a picture frame, and fixes the optical sheets 21 to 23 and the transparent organic EL sheet 30 to a mount surface of the low-height chassis 4 at both ends. The optical sheets 21 to 23 are used for adjusting the property of the light irradiated from the CCFL 24 into the liquid crystal display panel 2, which may be formed as a diffusion plate 21, a diffusion sheet 22, and a lens sheet 23.

The plural CCFLs 24 arranged in rows inside the chassis 4 are turned ON upon application of a high pulse voltage generated by an inverter circuit (not shown) disposed on a back surface of the chassis 4. The reflection sheet 40 provided below the CCFL 24 reflects the light therefrom to the liquid crystal display panel 2. In this case, the reflection sheet 40 according to the present invention is allowed to partially or entirely change the reflectance of the surface. The electronic paper is applicable to the structure of the aforementioned reflection sheet 40 with the aforementioned function.

The reflection sheet 40 with the structure of the electronic paper is formed by interposing capsules 45 each formed of white migrating particles 43, which reflect light, and a black insulating liquid 44 between a pair of transparent substrates 41 and 42. Upon voltage application between those transparent substrates 41 and 42, the migrating particles 43 gather on the respective surfaces of the transparent substrates 41 and 42 through the insulating liquid 44. The direction for applying the voltage to the migrating particle 43 is controlled for the display.

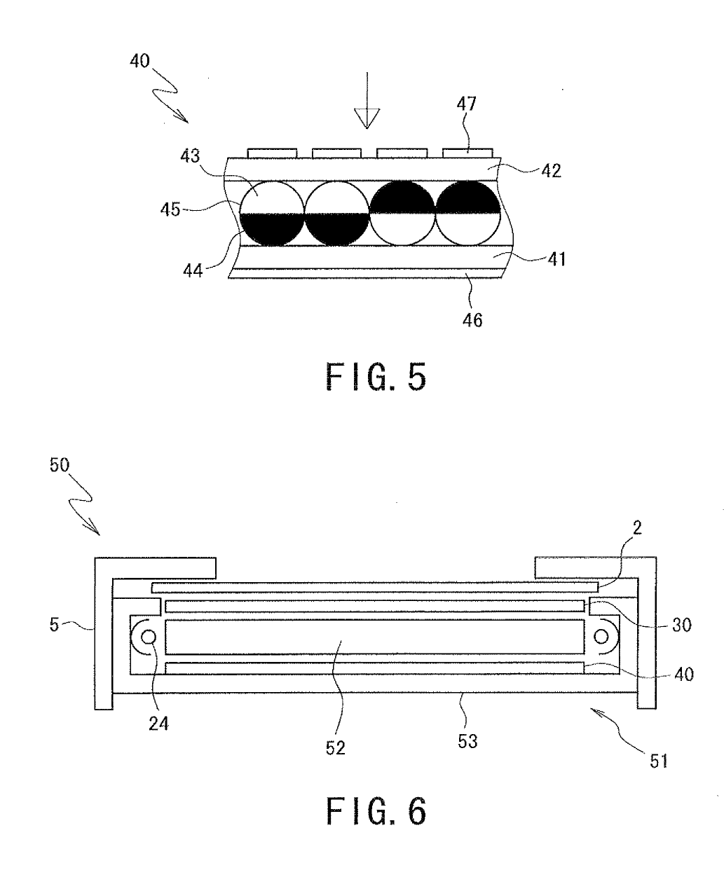

In the aforementioned case, an electrode 46 is formed to have a stripe arrangement below the transparent substrate 41, and an electrode 47 is formed to have the stripe arrangement on the transparent substrate 42 in a direction orthogonal to the electrode 46. Those electrodes 46 and 47 are arranged so as to supply the voltage to the migrating particles 43. The first and the second capsules 45 from the left are white displayed, and the third and the fourth capsules 45 are black displayed when viewed from the arrow direction in FIG. 5.

The above-structured reflection sheet 40 is matrix controlled by a reflectance control unit 18c of the control circuit 18 as illustrated in FIG. 2 for partially or entirely changing the reflectance of the surface. Specifically, the reflectance control unit 18c allows a partial or entire black-and-white display on the surface of the reflection sheet 40.

The transparent organic EL sheet 30 according to the present invention is interposed between the diffusion plate 21 and the diffusion sheet 22 each as the optical sheet as described above. Referring to FIG. 4, a stripe-like arranged transparent anode layer 32 formed of an indium-tin oxide (ITO), a hole transport layer 33, an organic EL light emitting layer 34, an electron transport layer 35, and a stripe-like arranged transparent cathode layer 36 formed of the ITO orthogonal to the transparent anode layer 32 are sequentially laminated in the aforementioned order on the transparent substrate 31 through the vacuum deposition method.

When the voltage is applied between the transparent anode layer 32 and the transparent cathode layer 36 of the thus structured transparent organic EL sheet 30, the hole injected from the transparent anode layer 32 via the hole transport layer 33 and the electron injected from the transparent cathode layer 36 via the electron transport layer 35 reach the organic EL light emitting layer 34 to cause recombination of the electron and the hole. The electric energy derived from the recombination is converted into the optical energy in the organic EL light emitting layer 34 for light emission. The inorganic EL light emitting layer may be employed as the transparent light emitting layer. This makes it possible to use the transparent inorganic EL sheet instead of the transparent organic EL sheet. The term “EL” is an abbreviation of the electro luminescence. The organic EL may also be called OLED (Organic Light Emitting Diode).

The transparent organic EL sheet 30 is matrix controlled by a light emission control unit 18b installed in the control circuit 18 as shown in FIG. 2 for partial or entire light emission on the surface.

In the aforementioned case, the hole transport layer 33, the organic EL light emitting layer 34 and the electron transport layer 35 are all substantially transparent as well as the transparent substrate 31, the transparent anode layer 32, and the transparent cathode layer 36. Accordingly, the transparent organic EL sheet 30 is substantially transparent in a non-luminous state. In the state where the transparent organic EL sheet 30 is interposed between the liquid crystal display panel 2 and the CCFL 24 as the light source as illustrated in FIG. 1, only the light from the CCFL 24 is irradiated to the liquid crystal display panel 2 so long as the transparent organic EL sheet 30 is kept in the non-luminous state. When the transparent organic EL sheet 30 is brought into the luminous state, the light therefrom may be irradiated to the liquid crystal display panel 2 together with the light from the CCFL 24.

Referring to FIG. 1, a bright image 2a and a dark image 2b are displayed on the liquid crystal display panel 2 under the matrix control executed by the display control unit 18a. Corresponding to those images 2a and 2b on the liquid crystal display panel 2, a luminous region 30a and a non-luminous region 30b are formed on the transparent organic EL sheet 30 under the matrix control executed by the light emission control unit 18b. In this case, based on the image data input from the display control unit 18a, the light emission control unit 18b selects either the luminous region 30a or the non-luminous region 30b, based on which the transparent organic EL sheet 30 is brought into the luminous state.

As the non-luminous region 30b on the transparent organic EL sheet 30 is substantially transparent, the light from the CCFL 24 is irradiated to the dark image 2b on the liquid crystal display panel 2. The light from the luminous region 30a on the transparent organic EL sheet 30 is irradiated to the bright image 2a on the liquid crystal display panel 2 together with the light from the CCFL 24 and the light reflecting from the reflection sheet 40.

As the light from the luminous region 30a on the transparent organic EL sheet 30 as well as the light from the CCFL 24 is irradiated to the bright image 2a on the liquid crystal display panel 2, the bright image 2a thereon is displayed brighter than the general case where only the light from the CCFL 24 is irradiated. Since only the light from the CCFL 24 is irradiated to the dark image 2b on the liquid crystal display panel 2, the dark image 2b is displayed thereon dark as usual.

The thus structured transparent organic EL sheet 30 is capable of emphasizing white portion of the bright display of the image on the liquid crystal display panel 2. This makes it possible to intensify the peak luminance at the brightest part (white) while keeping the darkest part (black) of the image displayed on the liquid crystal display panel 2 dark as usual, thus improving the contrast ratio.

Referring to FIG. 1, corresponding to the images 2a and 2b on the liquid crystal display panel 2, a white display region 40a and a black display region 40b are formed on the surface of the reflection sheet 40 under the matrix control executed by the reflectance control unit 16c. In this case, based on the image data input from the display control unit 18a, the reflectance control unit 18c selects either the white display region 40a or the black display region 40b, depending on which the reflectance of the surface of the reflection sheet 40 is changed.

The white display region 40a on the reflection sheet 40 reflects the light from the CCFL 24 and from the luminous region 30a on the transparent organic EL sheet 30 to the liquid crystal display panel 2. The black display region 40b on the reflection sheet 40 reflects the light from the CCFL 24 at a reflectance lower than that in the case of the white display region 40a. The intensity of the light reflected from the black display region 40b to the liquid crystal display panel 2 is lower than that of the light reflected from the white display region 40a to the liquid crystal display panel 2.

The light reflecting from the reflection sheet 40 and irradiated to the bright image 2a on the liquid crystal display panel 2 is the light reflecting from the white display region 40a on the reflection sheet 40 at high reflectance. The light reflecting from the reflection sheet 40 and irradiated to the dark image 2b on the liquid crystal display panel 2 is the light reflecting from the black display region 40b on the reflection sheet 40 at low reflectance. The dark image 2b is, thus, displayed darker than usual on the liquid crystal display panel 2.

The thus structured reflection sheet 40 allows the black portion of the dark display of the image on the liquid crystal display panel 2 to be further darkened. This makes it possible to further darken the black portion of the darkest part (black) on the liquid crystal display panel 2, thus improving the contrast ratio.

Since the liquid crystal display device 1 is provided with the transparent organic EL sheet 30 and the reflection sheet 40 as described above, light from the CCFL 24 and light from the luminous region 30a on the transparent organic EL sheet 30 are irradiated to the bright image 2a on the liquid crystal display panel 2 as well as that reflecting from the white display region 40a on the reflection sheet 40 at high reflectance. So the bright image 2a may be displayed further brighter on the liquid crystal display panel 2. The light from the CCFL 24 and that reflected from the black display region 40b on the reflection sheet 40 at low reflectance are only irradiated to the dark image 2b on the liquid crystal display panel 2. Accordingly, the dark image 2b may be displayed further darker on the liquid crystal display panel 2.

The synergistic effect derived from functions of the transparent organic EL sheet 30 and the reflection sheet 40 allows the black portion of the darkest part (black) to be displayed even darker while intensifying the peak luminance at the brightest part (white) of the image displayed on the liquid crystal display panel 2, thus improving the contrast ratio.

A first modified example of the liquid crystal display device 1 according to the aforementioned preferred embodiment will be described. An illuminating device 51 of a liquid crystal display device 50 as shown in FIG. 6 has the CCFL 24 disposed at sides of the liquid crystal display panel 2. The same structures as those described in the preferred embodiment will be designated with the same reference numerals, and explanations thereof, thus will be omitted. The different structure will only be described hereinafter.

In the example, the light from the CCFL 24 is irradiated to the liquid crystal display panel 2 by a light guide plate 52 as an optical member. The transparent organic EL sheet 30 according to the present invention as described above is disposed at the back surface side of the liquid crystal display panel 2, that is, between the liquid crystal display panel 2 and the light guide plate 52. The reflection sheet 40 according to the present invention is also provided at the back surface side of the light guide plate 52.

The CCFL 24, the transparent organic EL sheet 30, the light guide plate 52, and the reflection sheet 40 are stored in a low-height chassis 53 of the illuminating device 51. The liquid crystal display panel 2 is fixed to the chassis 53 with the bezels 5.

The thus structured liquid crystal display device 50 provided with the transparent organic EL sheet 30 and the reflection sheet 40 according to the present invention is capable of providing the same effects as those obtained from the present invention as described above. This makes it possible to darken the black portion of the darkest part (black) while intensifying the peak luminance at the brightest part (white) of the image displayed on the liquid crystal display panel 2, thus improving the contrast ratio.

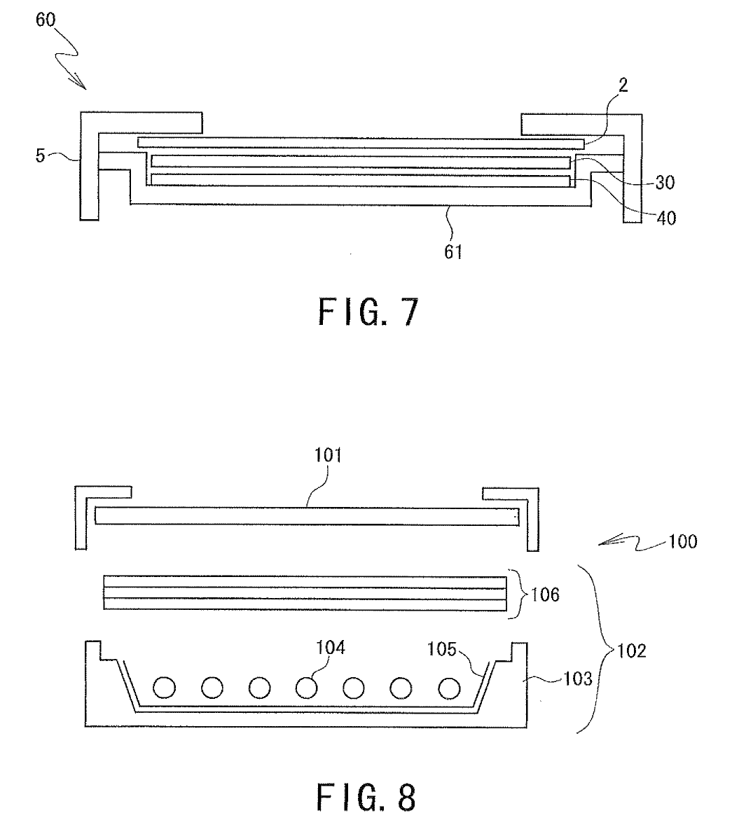

A second modified example of the liquid crystal display device 1 according to the preferred embodiment will be described. A liquid crystal display device 60 illustrated in FIG. 7 is structured to display the image by reflecting the external light such as sunlight to the liquid crystal display panel 2 using the reflection sheet 40 disposed at the back surface side of the liquid crystal display panel 2 without using a light source such as the CCF, 24 as described above. The same structures as those described in the aforementioned preferred embodiment will be designated with the same reference numerals, and explanations thereof, thus will be omitted. The different structure will be described.

Referring to the drawing, the external light is reflected to the liquid crystal display panel 2 by the reflection sheet 40 according to the present invention. The transparent organic EL sheet 30 is disposed at the back surface side of the liquid crystal display panel 2, that is, between the liquid crystal display panel 2 and the reflection sheet 40.

The transparent organic EL sheet 30 and the reflection sheet 40 are stored in a low-height chassis 61. The liquid crystal display panel 2 is fixed to the chassis 61 with the bezels 5.

The thus structured liquid crystal display device 60 provided with the transparent organic EL sheet 30 and the reflection sheet 40 is capable of providing the same effects as those obtained from the present invention. This makes it possible to further darken the black portion of the darkest part (black) while intensifying the peak luminance at the brightest part (white) of the image displayed on the liquid crystal display panel 2, thus improving the contrast ratio.

Having been described with respect to the preferred embodiment of the present invention, it is to be easily understood that the present invention is not limited to the preferred embodiment, and may be made into various forms without departing from the scope of the present invention. For example, a transparent inorganic EL sheet may be employed instead of the transparent organic EL sheet. The structure of the electronic paper used as the reflection sheet is not limited to the one as described in the preferred embodiment. The electronic paper with the structure of various types may be employed.

The CCFL 24 is employed as the light source for irradiating the light to the liquid crystal display panel 2 in the preferred embodiment. However, the surface-emitting light source formed by arranging plural LEDs on the plane is applicable without being limited to the CCFL as described above.

1. An illuminating device for irradiating light from a light source to a display panel, the illuminating device comprising:
a transparent EL sheet which is disposed at a back surface side of the display panel and kept transparent in a non-luminous state; and
a reflection sheet which reflects the light from the light source to the display panel,
wherein when at least a part of a surface of the transparent EL sheet is brought into a luminous state corresponding to image display on the display panel, a light emitted is irradiated to the display panel together with the light from the light source and the light reflecting from the reflection sheet.

2. The illuminating device according to claim 1, wherein the transparent EL sheet is one of a transparent organic EL sheet and a transparent inorganic EL sheet.

3. The illuminating device according to claim 1, wherein the display panel is a liquid crystal display panel.

4. The illuminating device according to claim 1, wherein a reflectance of at least a part of a surface of the reflection sheet is changed corresponding to the image display on the display panel.

5. The illuminating device according to claim 4, wherein the reflection sheet is electronic paper.

6. The illuminating device according to claim 1, wherein the light source is arranged on a back surface of the display panel.

7. The illuminating device according to claim 1, wherein the light source is arranged at a side edge of the display panel.

8. A display device for performing image display by irradiating light from a light source to a display panel, the display device comprising:
a transparent EL sheet which is disposed at a back surface side of the display panel and kept transparent in a non-luminous state;
a reflection sheet which reflects the light from the light source to the display panel;
a display control unit which controls the image display on the display panel; and
a light emission control unit which controls light emission on the transparent EL sheet,
wherein when the light emission control unit brings at least a part of a surface of the transparent EL sheet into a luminous state corresponding to the image display on the display panel controlled by the display control unit, an emitted light is irradiated to the display panel together with the light from the light source and the light reflecting from the reflection sheet.

9. The display device according to claim 8, wherein the transparent EL sheet is one of a transparent organic EL sheet and a transparent inorganic EL sheet.

10. The display device according to claim 8, wherein the display panel is a liquid crystal display panel.

11. The display device according to claim 8, further comprising a reflectance control unit which controls a reflectance of a surface of the reflection sheet, wherein the reflectance control unit changes the reflectance of at least a part of a surface of the reflection sheet corresponding to the image display on the display panel.

12. The display device according to claim 11, wherein the reflection sheet is electronic paper.

13. The display device according to claim 8, wherein the light source is arranged on a back surface of the display panel.

14. The display device according to claim 8, wherein the light source is arranged at a side edge of the display panel.

15. A display device for performing image display by reflecting external light such as sunlight to a display panel using a reflection sheet arranged at a back surface side of the display panel, the display device comprising:
a transparent EL sheet which is interposed between the display panel and the reflection sheet, and kept transparent in a non-luminous state;
a display control unit which controls the image display on the display panel; and
a light emission control unit which controls light emission on the transparent EL sheet,
wherein when the light emission control unit brings at least a part of a surface of the transparent EL sheet into a luminous state corresponding to the image display on the display panel controlled by the display control unit, an emitted light is irradiated to the display panel together with the light reflecting from the reflection sheet.

16. The display device according to claim 15, wherein the transparent EL sheet is one of a transparent organic EL sheet and a transparent inorganic EL sheet.

17. The display device according to claim 15, wherein the display panel is a liquid crystal display panel.

18. The display device according to claim 15, further comprising a reflectance control unit which controls a reflectance of a surface of the reflection sheet, wherein the reflectance control unit changes the reflectance of at least a part of the surface of the reflection sheet corresponding to the image display on the display panel.

19. The display device according to claim 18, wherein the reflection sheet is an electronic paper.
